(19) United States
(12) Patent Application Publication
(10) Pub. No.: US 2026/0316465 A1
(43) Pub. Date: Oct. 15, 2026

(54) IMAGE FORMING APPARATUS

(71) Applicant: KYOCERA Document Solutions Inc., Osaka (JP)

(72) Inventor: Toshiki Kawamura, Osaka (JP)

(21) Appl. No.: 19/466,922

(22) Filed: Feb. 2, 2026

(30) Foreign Application Priority Data
Feb. 12, 2025 (JP) 2025-020597

(51) Int. Cl. B41J 13/08; B41J 3/60; B41J 13/02; G03G 15/00; G03G 21/16

(52) U.S. Cl. CPC B41J 13/08; B41J 3/60; B41J 13/02; G03G 15/6576; G03G 21/1619; G03G 21/1642; G03G 21/1647; B65H 2402/60; G03G 2221/1654

(57) ABSTRACT

A movable member has a first through portion and a second through portion through which a support shaft passes, and a first contact surface and a second contact surface. In a support state in which a support mechanism supports a first protruding portion and a second protruding portion of a processing unit at a target position, the support shaft contacts a lower edge portion of a first through hole in the first through portion, the first contact surface sandwiches the first protruding portion between the first contact surface and a first support portion due to a biasing force of a biasing member, the second contact surface sandwiches the second protruding portion between the second protruding portion and a second support portion, and lower and upper edge portions of a second through hole in the second through portion do not contact the support shaft.

### INCORPORATION BY REFERENCE

This application is based upon and claims the benefit of priority from the corresponding Japanese Patent Application No. 2025-020597 filed on Feb. 12, 2025, the entire contents of which are incorporated herein by reference.

### BACKGROUND

The present disclosure relates to an image forming apparatus including a processing unit that executes processing related to a printing process.

The image forming apparatus includes one or more processing units attached to a main body. The processing unit executes processing related to a printing process.

For example, it is known that the image forming apparatus includes the processing unit such as a conveying unit that adjusts timing of conveying a sheet to a printing position.

### SUMMARY

An image forming apparatus according to one aspect of the present disclosure includes a main body and a processing unit attached to the main body. The processing unit executes processing related to a printing process for conveying a sheet and forming an image on the sheet being conveyed. The processing unit has a unit housing that houses devices, and a first protruding portion and a second protruding portion that protrude from a first end of the unit housing in a lengthwise direction. The main body has a support mechanism that supports the first protruding portion and the second protruding portion at target positions. The support mechanism includes a support shaft, a movable member, a biasing member, a first support portion, and a second support portion. The support shaft is arranged in a specific direction along a horizontal direction. The movable member has a first through portion and a second through portion through which the support shaft passes, and a first contact surface and a second contact surface that contact the first protruding portion and the second protruding portion, respectively, and is supported by the support shaft so as to be slidable in the specific direction. The biasing member biases the movable member toward a first side in the specific direction. The first support portion supports a lower end of the first protruding portion and a side end on a first side of the first protruding portion. The second support portion is arranged on a second side in the specific direction relative to the first support portion and supports a lower end of the second protruding portion. The second through portion is formed on the second side relative to the first through portion. The second contact surface is formed on the second side relative to the first contact surface. The first contact surface and the second contact surface are each formed obliquely with respect to the specific direction. In a support state in which the support mechanism supports the first protruding portion and the second protruding portion at the target positions, the support shaft restricts upward movement of the first through portion by contacting a lower edge portion of a first through hole in the first through portion through which the support shaft passes. In the support state, the first contact surface, by pressing the first protruding portion obliquely downward toward the first side by a biasing force of the biasing member, sandwiches the first protruding portion between the first contact surface and the first support portion. In the support state, the second contact surface, by pressing the second protruding portion obliquely downward toward the first side by the biasing force of the biasing member, sandwiches the second protruding portion between the second contact surface and the second support portion. In the support state, lower and upper edge portions of the second through hole in the second through portion, through which the support shaft passes, do not come into contact with the support shaft.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an image forming apparatus according to an embodiment.

FIG. 2 is a diagram showing a configuration of a sheet correction unit in an image forming apparatus according to an embodiment.

FIG. 3 is a simplified perspective view of a sheet correction unit in an image forming apparatus according to an embodiment.

FIG. 4 is a simplified front view of a sheet correction unit in an image forming apparatus according to an embodiment.

FIG. 5 is a simplified rear view of a sheet correction unit in an image forming apparatus according to an embodiment.

FIG. 6 is a diagram showing a process of attaching a sheet correction unit in an image forming apparatus according to an embodiment.

FIG. 7 is a configuration diagram of a rear support mechanism in an image forming apparatus according to an embodiment.

FIG. 8 is a perspective view of a front support mechanism in an image forming apparatus according to an embodiment.

FIG. 9 is a diagram showing a front support mechanism in an unattached state in an image forming apparatus according to an embodiment.

FIG. 10 is a view showing a front support mechanism while in progress of attaching a sheet correction unit in an image forming apparatus according to an embodiment.

FIG. 11 is a diagram showing a front support mechanism in an attached state in an image forming apparatus according to an embodiment.

### DETAILED DESCRIPTION

Hereinafter, an embodiment according to the present disclosure will be described with reference to the drawings. Note that the following embodiments are examples of a specific embodiment according the present disclosure, and do not limit the technical scope of the present disclosure.

### First Embodiment

An image forming apparatus 10 according to a first embodiment is capable of executing a printing process in which a sheet is conveyed and an image is formed on the sheet being conveyed.

The image forming apparatus 10 includes a main body 1, a sheet storing portion 2, a sheet conveying device 3, and a printing device 4. The main body 1 is a housing that internally houses devices including the sheet storing portion 2, the sheet conveying device 3, and the printing device 4.

The sheet conveying device 3 feeds out a sheet 9 stored in the sheet storing portion 2 to a main conveying path 301, and further conveys the sheet 9 along the main conveying path 301. The main conveying path 301 includes a front conveying path 301a and a rear conveying path 301b.

The front conveying path 301a is arranged on an upstream side in a sheet conveying direction of a printing position where an image is formed on the sheet 9. The rear conveying path 301b is arranged on a downstream side in the sheet conveying direction of the printing position.

In a case in which double-sided printing is executed, the sheet conveying device 3 executes a reverse conveying process on the sheet 9 having an image formed on a first side. The reverse conveying process includes a process of conveying the sheet 9 from the rear conveying path 301b to a reverse conveying path 302, a process of reversing the sheet 9 in the reverse conveying path 302, and a process of conveying the sheet 9 from the reverse conveying path 302 to the front conveying path 301a.

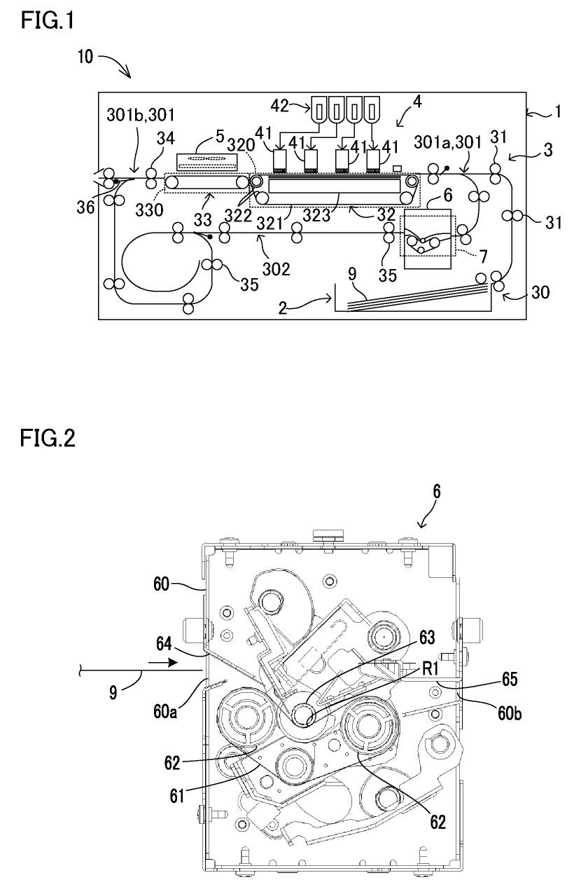

In the example shown in FIG. 1, the sheet conveying device 3 includes a sheet feeding mechanism 30, a plurality of sets of first conveying roller pairs 31, a first belt conveying device 32, a second belt conveying device 33, a plurality of sets of second conveying roller pairs 34, and a plurality of sets of third conveying roller pairs 35.

The sheet feeding mechanism 30 feeds out the sheet 9 from the sheet storing portion 2 to the front conveying path 301a. The first conveying roller pair 31 conveys the sheet 9 along the front conveying path 301a and feeds the sheet 9 to the printing position.

The first belt conveying device 32 conveys the sheet 9 at the printing position and feeds the sheet 9 on which the image has been formed to the second belt conveying device 33. The second belt conveying device 33 takes over conveying the sheet 9 from the first belt conveying device 32, and further feeds the sheet 9 to the rear conveying path 301b.

The sheet conveying device 3 further includes a movable guide mechanism 36 that selectively guides the sheet 9 to either a first path or a second path in the rear conveying path 301b. The first path is a path leading from the rear conveying path 301b toward a rear stage of the rear conveying path 301b. The rear stage is a sheet discharge tray or a post-processing device. The second path is a path leading from the rear conveying path 301b to the reverse conveying path 302.

When the movable guide mechanism 36 guides the sheet 9 to the first path, the second conveying roller pair 34 conveys the sheet 9 from the rear conveying path 301b to the rear stage. When the movable guide mechanism 36 guides the sheet 9 to the second path, the second conveying roller pair 34 conveys the sheet 9 from the rear conveying path 301b to the reverse conveying path 302.

In the present embodiment, the printing device 4 forms an image on the sheet 9 by inkjet printing. The printing device 4 includes a plurality of inkjet heads 41 that eject ink onto the sheet 9 conveyed by the first belt conveying device 32, and an ink supply device 42 that supplies ink to the plurality of inkjet heads 41.

The first belt conveying device 32 includes a plurality of support rollers 322 and an endless conveying belt 321 rotatably supported by the plurality of support rollers 322. The first belt conveying device 32 further includes a suction device 323 that sucks the sheet 9 onto a flat upper surface of the conveying belt 321.

The image forming apparatus 10 also includes a drying device 5 that dries the ink on the sheet 9 conveyed by the second belt conveying device 33. For example, the drying device 5 blows hot air onto the sheet 9 being conveyed by the second belt conveying device 33.

The image forming apparatus 10 further includes a sheet correction unit 6 that corrects a shape of the sheet 9 in the reverse conveying path 302. The sheet correction unit 6 corrects the shape of the sheet 9 so that front and rear ends of the sheet 9 on the conveying belt 321 of the first belt conveying device 32 are curved in a direction approaching the conveying belt 321.

As shown in FIG. 2, the sheet correction unit 6 includes a unit housing 60 that internally houses devices, an endless belt member 61, a plurality of support rollers 62, and a correction roller 63.

The belt member 61 is rotatably supported by the plurality of support rollers 62. The correction roller 63 comes in contact with an outer surface of the belt member 61 and rotates together with the belt member 61. The correction roller 63 forms a curved path R1 along which the sheet 9 passes between the correction roller 63 and the belt member 61.

The belt member 61, the plurality of support rollers 62 and the correction roller 63 are arranged in the unit housing 60 along a lengthwise direction of the unit housing 60. The depth direction in FIG. 2 corresponds to the lengthwise direction of the unit housing 60, the belt member 61, the plurality of support rollers 62 and the correction roller 63.

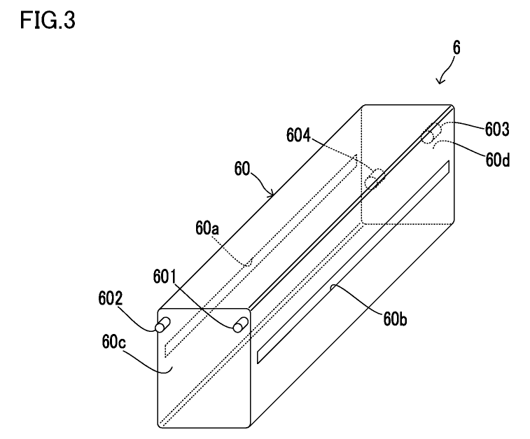

The unit housing 60 has an entrance opening 60a and an exit opening 60b formed along the lengthwise direction of the unit housing 60 (see FIG. 3). In the middle of the reverse conveying path 302, the sheet 9 is conveyed into a curved path R1 inside the unit housing 60 through the entrance opening 60a, and is conveyed out of the unit housing 60 through the exit opening 60b.

The sheet correction unit 6 further includes an entrance guide 64 and an exit guide 65. The entrance guide 64 guides the sheet 9 from the entrance opening 60a to the curved path R1. The exit guide 65 guides the sheet 9 from the curved path R1 to the exit opening 60b.

The sheet correction unit 6 is an example of a processing unit that executes processing related to the printing process. In addition, a first conveying unit 320 including the first belt conveying device 32 and a second conveying unit 330 including the second belt conveying device 33 are also examples of the processing units attached to the main body 1.

It is desirable that the sheet correction unit 6 can be easily positioned at a target position in the main body 1. The image forming apparatus 10 includes a configuration for easily positioning the sheet correction unit 6 at a target position in the main body 1.

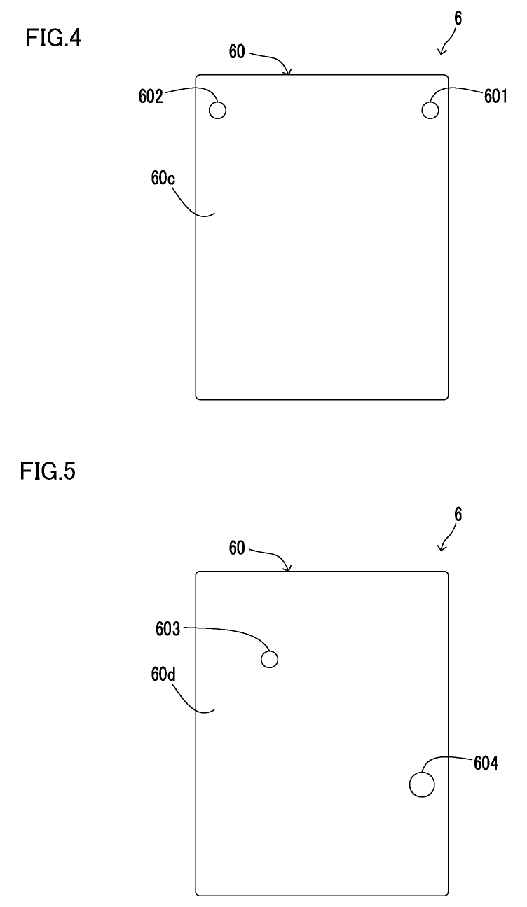

The sheet correction unit 6 has a first protruding portion 601 and a second protruding portion 602 that each protrude from a front surface 60c of the unit housing 60 (see FIGS. 3 and 4). The front surface 60c of the unit housing 60 is a surface of a first end of the unit housing 60 in the lengthwise direction.

The first protruding portion 601 and the second protruding portion 602 are each cylindrical and extend along the lengthwise direction of the unit housing 60.

Furthermore, the sheet correction unit 6 has a third protruding portion 603 and a fourth protruding portion 604 that protrude from a rear surface 60d of the unit housing 60 (see FIGS. 3 and 5). The rear surface 60d of the unit housing 60 is a surface at a second end in the lengthwise direction of the unit housing 60.

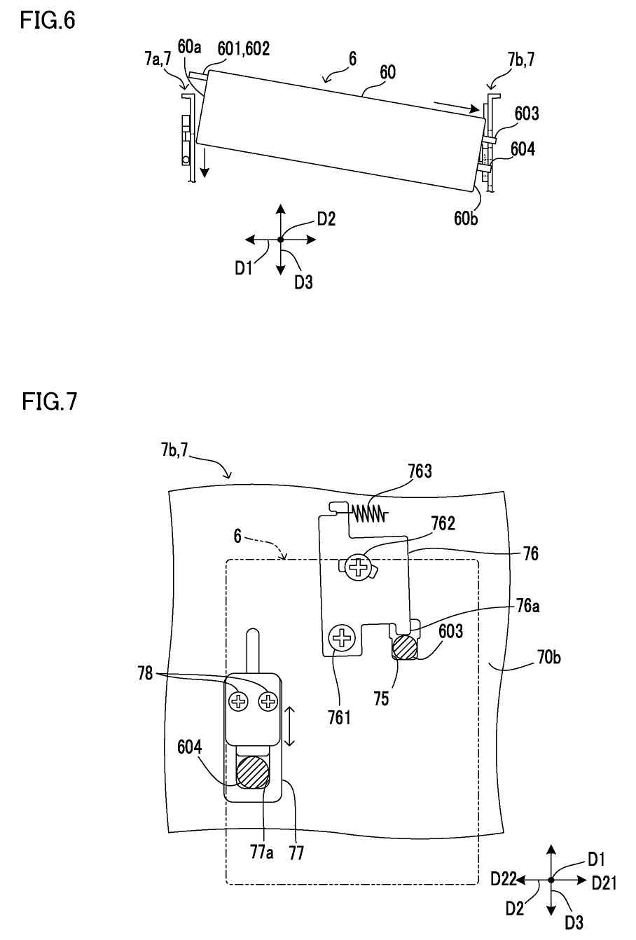

The main body 1 has a support mechanism 7 that supports the sheet correction unit 6 inside the main body 1 (see FIG. 1). The support mechanism 7 includes a front support mechanism 7a that supports the first protruding portion 601 and the second protruding portion 602 at target positions on the front surface side, and a rear support mechanism 7b that supports the third protruding portion 603 and the fourth protruding portion 604 at target positions on the rear side (see FIG. 6).

In the following description, a depth direction of the main body 1 is referred to as a first direction D1, and the direction perpendicular to the first direction D1 and parallel to a horizontal direction is referred to as a second direction D2 (see FIGS. 6-11). Furthermore, one side in the second direction D2 is referred to as a first side D21, and the other side in the second direction D2 is referred to as a second side D22 (see FIGS. 6-11).

In addition, a direction perpendicular to the first direction D1 and the second direction D2 is referred to as a third direction D3 (see FIGS. 6-11).

The second direction D2 is an example of a specific direction along the horizontal direction. The third direction D3 is an up-down direction. The sheet correction unit 6 is attached to the main body 1 in a position such that the lengthwise direction of the unit housing 60 is along the first direction D1.

The sheet correction unit 6 is inserted into the main body 1 obliquely downward with the third protruding portion 603 and the fourth protruding portion 604 at the front (see FIG. 6). Furthermore, by moving the front surface 60c of the unit housing 60 downward in a state in which the third protruding portion 603 and the fourth protruding portion 604 are supported by the rear support mechanism 7b, the first protruding portion 601 and the second protruding portion 602 are supported by the front support mechanism 7a.

The rear support mechanism 7b includes a first rear support portion 75 and a second rear support portion 77 that are spaced apart in the second direction D2 (see FIG. 7). The first rear support portion 75 is fixed to the main body 1. The second rear support portion 77 is supported by the main body 1 so as to be movable in the third direction D3.

The rear support mechanism 7b includes a rear support plate 70b fixed to the main body 1. The first rear support portion 75 is formed on the rear support plate 70b. The first rear support portion 75 has an opening formed therein into which the third protruding portion 603 is internally fitted (see FIG. 7).

The rear support mechanism 7b further includes a pivoting member 76 pivotally supported by the rear support plate 70b, and a spring 763 that biases the pivoting member 76 (see FIG. 7). In the example shown in FIG. 7, the pivoting member 76 is fixed to the rear support plate 70b by a first screw 761 and a second screw 762 (see FIG. 7).

When the second screw 762 is loosened, the pivoting member 76 can pivot around the first screw 761. The pivoting member 76 has a contact portion 76athat comes in contact with the third protruding portion 603 internally fitted into the first rear support portion 75.

The spring 763 biases the pivoting member 76 in a direction in which the contact portion 76a presses the third protruding portion 603 against the first rear support portion 75. Thus, the third protruding portion 603 is firmly supported by the first rear support portion 75.

On the other hand, the second rear support portion 77 has an opening 77a formed therein into which the fourth protruding portion 604 is internally fitted (see FIG. 7). The second rear support portion 77 is supported by the rear support plate 70b so as to be movable in the third direction D3.

The rear support mechanism 7b further includes a fixing mechanism 78 that fixes the second rear support portion 77 at any position within a movable range of the second rear support portion 77. In the present embodiment, the fixing mechanism 78 is one or more screws that fix the second rear support portion 77 to the rear support plate 70b.

The first rear support portion 75 is an example of a third support portion that supports the third protruding portion 603, and the second rear support portion 77 is an example of a fourth support portion that supports the fourth protruding portion 604.

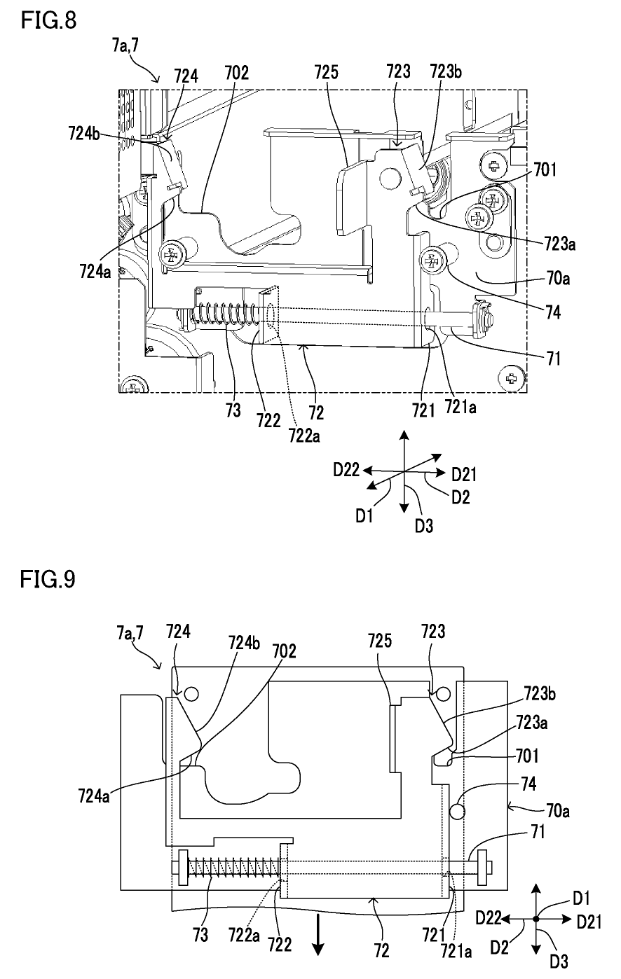

On the other hand, the front support mechanism 7a includes a front support plate 70a, a support shaft 71, and a movable member 72 and a spring 73 each supported by the support shaft 71 (see FIG. 8). The front support plate 70ais fixed to the main body 1, and the support shaft 71 is fixed to the front support plate 70a.

The front support plate 70a has a first front support portion 701 and a second front support portion 702 that support the first protruding portion 601 and the second protruding portion 602 of the sheet correction unit 6, respectively. The second front support portion 702 is arranged on a second side D22 in a second direction D2 relative to the first front support portion 701.

The first front support portion 701 supports a lower end of the first protruding portion 601 and a side end of the first protruding portion 601 on the first side D21 (see FIG. 11). The second front support portion 702 supports a lower end of the second protruding portion 602 (see FIG. 11).

The first front support portion 701 is an example of a first support portion that supports the first protruding portion 601, and the second front support portion 702 is an example of a second support portion that supports the second protruding portion 602.

The support shaft 71 is arranged along the second direction D2. The movable member 72 is supported by the support shaft 71 so as to be slidable along the second direction D2. The movable member 72 has a first through portion 721 and a second through portion 722 through which the support shaft 71 passes (see FIG. 8).

The first through portion 721 is formed with a first through hole 721a through which the support shaft 71 passes, and the second through portion 722 is also formed with a second through hole 722a through which the support shaft 71 passes (see FIGS. 8-11). The second through portion 722 is formed on a second side D22 in the second direction D2 relative to the first through portion 721.

The spring 73 biases the movable member 72 toward the first side D21 in the second direction D2. The spring 73 is an example of a biasing member.

Furthermore, the front support mechanism 7a includes a stopper 74 fixed to the front support plate 70a (see FIG. 8). The stopper 74 limits the range of movement of the first side D21 of the movable member 72 to a predetermined reference position (see FIGS. 8 and 9).

Furthermore, the movable member 72 has a first locking portion 723 and a second locking portion 724 (see FIGS. 8-11). The first locking portion 723 locks the first protruding portion 601 at a position where the first protruding portion 601 is supported by the first front support portion 701 (see FIG. 11). The second locking portion 724 locks the second protruding portion 602 at a position where the second protruding portion 602 is supported by the second front support portion 702 (see FIG. 11).

The first locking portion 723 has a first contact surface 723a that comes in contact with the first protruding portion 601, and the second locking portion 724 has a second contact surface 724a that comes in contact with the second protruding portion 602 (see FIGS. 8-11). The second contact surface 724a is formed on the second side D22 relative to the first contact surface 723a.

The first contact surface 723a and the second contact surface 724a are each formed obliquely with respect to the second direction D2. More specifically, the first contact surface 723aand the second contact surface 724a are surfaces that face diagonally downward on the first side D21.

In the present embodiment, the first locking portion 723 has a first sliding surface 723b, and the second locking portion 724 has a second sliding surface 724b (see FIGS. 8-11). The first sliding surface 723bis formed above the first contact surface 723a and obliquely with respect to the third direction D3. The second sliding surface 724bis formed above the second contact surface 724a and obliquely with respect to the third direction D3.

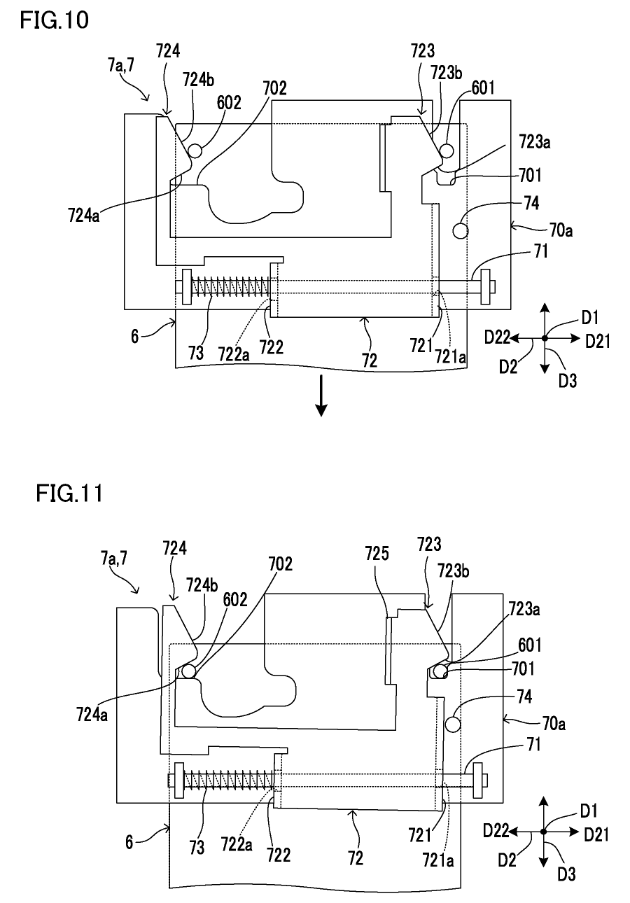

As the first protruding portion 601 and the second protruding portion 602 descend toward the first front support portion 701 and the second front support portion 702, respectively, the first protruding portion 601 and the second protruding portion 602 slide on the first sliding surface 723b and the second sliding surface 724b, respectively (see FIG. 10).

The movable member 72 moves from the reference position to the second side D22 in the second direction D2 against the biasing force of the spring 73 due to the force received from the first protruding portion 601 and the second protruding portion 602 as the first sliding surface 723b and the second sliding surface 724b descend (see FIG. 10).

Furthermore, the first protruding portion 601 and the second protruding portion 602 pass downward over the first sliding surface 723b and the second sliding surface 724b, respectively (see FIG. 11). At this time, the movable member 72 moves to the first side D21 due to the biasing force of the spring 73, and the first contact surface 723a and the second contact surface 724a come into contact with the first protruding portion 601 and the second protruding portion 602, respectively (see FIG. 11).

The first contact surface 723a and the second contact surface 724a come into contact with the first protruding portion 601 and the second protruding portion 602, respectively, due to the biasing force of the spring 73. Thus, the first locking portion 723 and the second locking portion 724 lock the first protruding portion 601 and the second protruding portion 602 at the target positions, respectively.

The target positions of the first protruding portion 601 and the second protruding portion 602 are positions supported by the first front support portion 701 and the second front support portion 702.

A state in which the first locking portion 723 and the second locking portion 724 lock the first protruding portion 601 and the second protruding portion 602 at the target positions is a support state in which the front support mechanism 7a supports the first protruding portion 601 and the second protruding portion 602 at the target positions. FIG. 11 shows the support state.

In the support state, the support shaft 71, by coming into contact with a lower edge portion of the first through hole 721a in the first through portion 721, restricts upward movement of the first through portion 721 (see FIG. 11).

That is, in the support state, the lower edge portion of the first through hole 721a comes into contact with a lower surface of the support shaft 71.

In the support state, the first contact surface 723a, by pressing the first protruding portion 601 diagonally downward toward the first side D21 due to the biasing force of the spring 73, sandwiches the first protruding portion 601 between the first contact surface 723a and the first front support portion 701 (see FIG. 11).

In the support state, the second contact surface 724a, by pressing the second protruding portion 602 diagonally downward toward the first side D21 due to the biasing force of the spring 73, sandwiches the second protruding portion 602 between the second contact surface 724a and the second support portion 702 (see FIG. 11).

On the other hand, in the support state, lower and upper edge portions of the second through hole 722a in the second through portion 722 do not come into contact with the support shaft 71. In the state shown in FIG. 11, the spring 73 exerts a biasing force in the D21 direction and a counterclockwise rotational moment on the movable member 72.

Therefore, in the support state, the first front support portion 701 and the first contact surface 723a position the sheet correction unit 6 in the second direction D2 and the third direction D3. Furthermore, in the support state, the second front support portion 702, the second contact surface 724a, and the support shaft 71 position the sheet correction unit 6 in the circumferential direction around the first protruding portion 601.

Note that a depth support mechanism (not shown) supports the position of the sheet correction unit 6 in the first direction D1.

In the front support mechanism 7a, even when there is a dimensional tolerance in the positional relationship between the first front support portion 701 and the second front support portion 702, or a dimensional tolerance in the positional relationship between the first contact surface 723a and the second contact surface 724a, the first protruding portion 601 and the second protruding portion 602 are supported at a fixed position. Similarly, even when a dimensional tolerance occurs in the positional relationship between the first through hole 721a and the second through hole 722a, the first protruding portion 601 and the second protruding portion 602 are supported at a fixed position.

Therefore, by employing the front support mechanism 7a, an end portion of the unit housing 60 on a front surface 60c side can be easily positioned at the target position on the main body 1.

In the present embodiment, a difference between a dimension of the second through hole 722a in the third direction D3 and a dimension of the support shaft 71 in the third direction D3 is greater than a difference between a dimension of the first through hole 721a in the third direction D3 and a dimension of the support shaft 71 in the third direction D3. In this case, the second through portion 722 is less likely to interfere with positioning of the sheet correction unit 6 in the circumferential direction around the first protruding portion 601.

In the present embodiment, the movable member 72 further includes a handle portion 725 (see FIGS. 8-11). By the handle portion 725 receiving a force toward the second side D22, the movable member 72 moves toward the second side D22 against the biasing force of the spring 73, and the engagement of the first protruding portion 601 and the second protruding portion 602 by the first locking portion 723 and the second locking portion 724 is released.

By the first locking portion 723 and the second locking portion 724 releasing the first protruding portion 601 and the second protruding portion 602 from each other, the sheet correction unit 6 can be removed from the main body 1.

In the support state in which the first protruding portion 601 and the second protruding portion 602 are supported by the front support mechanism 7a, the position of the second rear support portion 77 in the rear support mechanism 7b is adjusted.

Adjusting the position of the second rear support portion 77 in the support state is an adjustment of a twisted state of the unit housing 60 and an adjustment of a positional relationship of the plurality of support rollers 62 that support the belt member 61.

More specifically, the position of the second rear support portion 77 is adjusted so that the belt member 61 does not shift in position in the first direction D1 while the belt member 61 is rotating. The second rear support portion 77 is fixed at the adjusted position by a fixing mechanism 78.

Note that the support mechanism 7 may be employed as a mechanism for supporting the first conveying unit 320 or the second conveying unit 330.

In addition, the printing device 4 may also be a device that forms an image on the sheet 9 by electrophotography. In this case, the support mechanism 7 may be employed as a mechanism for supporting the transfer unit or the fixing unit.

The transfer unit transfers the toner image formed on the surface of the photoconductor onto an endless transfer belt member, and further transfers the toner image from the transfer belt member onto the sheet 9.

The fixing unit includes a heater and an endless fixing belt member heated by the heater. The fixing belt member heats the toner image on the sheet 9.

### Supplementary Notes

An outline of the technique according to the disclosure extracted from the above-described embodiments will be added below. Note that the configurations and processing functions described in the following supplementary notes can be selected and combined as desired.

### Supplementary Note 1

An image forming apparatus, including:
a main body; and
a processing unit attached to the main body and configured to execute processing related to a printing process for conveying a sheet and forming an image on the conveyed sheet; wherein
the processing unit has
a unit housing configured to house devices; and
a first protruding portion and a second protruding portion, each protruding from a first end of the unit housing in a lengthwise direction;
the main body has a support mechanism configured to support the first protruding portion and the second protruding portion at target positions;
the support mechanism includes:
a support shaft arranged in a specific direction along a horizontal direction;
a movable member having a first through portion and a second through portion through which the support shaft passes, and a first contact surface and a second contact surface that contact the first protruding portion and the second protruding portion, respectively, and supported by the support shaft so as to be slidable in the specific direction;
a biasing member configured to bias the movable member toward a first side in the specific direction;
a first support portion configured to support a lower end of the first protruding portion and a side end on a first side of the first protruding portion; and
a second support portion arranged on a second side in the specific direction with respect to the first support portion and configured to support a lower end of the second protruding portion;
the second through portion is formed on the second side relative to the first through portion;
the second contact surface is formed on the second side relative to the first contact surface;
the first contact surface and the second contact surface are each formed obliquely with respect to the specific direction;
in a support state in which the support mechanism supports the first protruding portion and the second protruding portion at the target position, the support shaft restricts upward movement of the first through portion by contacting a lower edge portion of a first through hole in the first through portion through which the support shaft passes;
the first contact surface, by pressing the first protruding portion obliquely downward toward the first side by a biasing force of the biasing member, sandwiches the first protruding portion between the first contact surface and the first support portion;
the second contact surface, by pressing the second protruding portion obliquely downward toward the first side by the biasing force of the biasing member, sandwiches the second protruding portion between the second contact surface and the second support portion; and
lower and upper edge portions of the second through hole in the second through portion, through which the support shaft passes, do not come into contact with the support shaft.

### Supplementary Note 2

The image forming apparatus according to Supplementary Note 1, wherein a difference between a dimension in an up-down direction of the second through hole and a dimension in the up-down direction of the support shaft is larger than a difference between a dimension in the up-down direction of the first through hole and a dimension in the up-down direction of the support shaft.

### Supplementary Note 3

The image forming apparatus according to Supplementary Notes 1 or 2, wherein
the processing unit has
a third protruding portion and a fourth protruding portion, each protruding from a second end of the unit housing in the lengthwise direction; and
the support mechanism includes:
a third support portion fixed to the main body and configured to form an opening into which the third protruding portion is fitted;
a fourth support portion supported by the main body so as to be movable in the up-down direction and configured to form an opening into which the fourth protruding portion is fitted; and
a fixing mechanism configured to fix the fourth support portion at any position within a movable range of the fourth support portion.

### Supplementary Note 4

The image forming apparatus according to Supplementary Note 3, wherein

the processing unit includes an endless belt member rotatably supported by a plurality of support rollers arranged in the unit housing along the lengthwise direction of the unit housing.

### Supplementary Note 5

The image forming apparatus according to Supplementary Note 4, wherein

the processing unit includes a correction roller configured to contact an outer surface of the belt member, rotate together with the belt member, and form a curved path along which the sheet passes between the correction roller and the belt member.

### Supplementary Note 6

The image forming apparatus according to any one of Supplementary Notes 1 to 5, wherein
the movable member has a first sliding surface and a second sliding surface that are formed above the first contact surface and the second contact surface at an angle with respect to the up-down direction, and on which the first protruding portion and the second protruding portion slide while descending toward the first support portion and the second support portion, respectively;
the movable member moves from a reference position to the second side in the specific direction against the biasing force of the biasing member due to a force received from the first protruding portion and the second protruding portion as the first sliding surface and the second sliding surface move downward; and
when the first protruding portion and the second protruding portion pass downward over the first sliding surface and the second sliding surface, respectively, the movable member moves toward the first side due to the biasing force of the biasing member, and the first contact surface and the second contact surface come in contact with the first protruding portion and the second protruding portion, respectively.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus, comprising:
a main body; and
a processing unit attached to the main body and configured to execute processing related to a printing process for conveying a sheet and forming an image on the conveyed sheet; wherein
the processing unit has
a unit housing configured to house devices; and
a first protruding portion and a second protruding portion, each protruding from a first end of the unit housing in a lengthwise direction;
the main body has a support mechanism configured to support the first protruding portion and the second protruding portion at target positions;
the support mechanism comprises:
a support shaft arranged in a specific direction along a horizontal direction;
a movable member having a first through portion and a second through portion through which the support shaft passes, and a first contact surface and a second contact surface that contact the first protruding portion and the second protruding portion, respectively, and supported by the support shaft so as to be slidable in the specific direction;
a biasing member configured to bias the movable member toward a first side in the specific direction;
a first support portion configured to support a lower end of the first protruding portion and a side end on a first side of the first protruding portion; and
a second support portion arranged on a second side in the specific direction with respect to the first support portion and configured to support a lower end of the second protruding portion;
the second through portion is formed on the second side relative to the first through portion;
the second contact surface is formed on the second side relative to the first contact surface;
the first contact surface and the second contact surface are each formed obliquely with respect to the specific direction;
in a support state in which the support mechanism supports the first protruding portion and the second protruding portion at the target position,
the support shaft restricts upward movement of the first through portion by contacting a lower edge portion of a first through hole in the first through portion through which the support shaft passes;
the first contact surface, by pressing the first protruding portion obliquely downward toward the first side by a biasing force of the biasing member, sandwiches the first protruding portion between the first contact surface and the first support portion;
the second contact surface, by pressing the second protruding portion obliquely downward toward the first side by a biasing force of the biasing member, sandwiches the second protruding portion between the second contact surface and the second support portion; and
lower and upper edge portions of the second through hole in the second through portion, through which the support shaft passes, do not come into contact with the support shaft.

2. The image forming apparatus according to claim 1, wherein
a difference between a dimension in an up-down direction of the second through hole and a dimension in the up-down direction of the support shaft is larger than a difference between a dimension in the up-down direction of the first through hole and a dimension in the up-down direction of the support shaft.

3. The image forming apparatus according to claim 1, wherein
the processing unit has
a third protruding portion and a fourth protruding portion, each protruding from a second end of the unit housing in the lengthwise direction; and
the support mechanism comprises:
a third support portion fixed to the main body and configured to form an opening into which the third protruding portion is fitted;
a fourth support portion supported by the main body so as to be movable in the up-down direction and configured to form an opening into which the fourth protruding portion is fitted; and
a fixing mechanism configured to fix the fourth support portion at any position within a movable range of the fourth support portion.

4. The image forming apparatus according to claim 3, wherein
the processing unit includes an endless belt member rotatably supported by a plurality of support rollers arranged in the unit housing along the lengthwise direction of the unit housing.

5. The image forming apparatus according to claim 4, wherein
the processing unit includes a correction roller configured to contact an outer surface of the belt member, rotate together with the belt member, and form a curved path along which the sheet passes between the correction roller and the belt member.

6. The image forming apparatus according to claim 1, wherein
the movable member has a first sliding surface and a second sliding surface that are formed above the first contact surface and the second contact surface at an angle with respect to the up-down direction, and on which the first protruding portion and the second protruding portion slide while descending toward the first support portion and the second support portion, respectively;
the movable member moves from a reference position to the second side in the specific direction against the biasing force of the biasing member due to a force received from the first protruding portion and the second protruding portion as the first sliding surface and the second sliding surface move downward; and
when the first protruding portion and the second protruding portion pass downward over the first sliding surface and the second sliding surface, respectively, the movable member moves toward the first side due to the biasing force of the biasing member, and the first contact surface and the second contact surface come in contact with the first protruding portion and the second protruding portion, respectively.
